(19) United States
(12) Patent Application Publication
(10) Pub. No.: US 2024/0192992 A1
(43) Pub. Date: Jun. 13, 2024

(54) SYSTEMS AND METHODS PROVIDING AUTOMATED ISSUE DIAGNOSIS FOR FLEET OF PHYSICAL RESOURCE DISPENSING MACHINES VIA MULTI-CHANNEL DATA SAMPLING

(71) Applicant: BANK OF AMERICA CORPORATION, Charlotte, NC (US)

(72) Inventors: James Dennis Goodwin, Holt, MO (US); Jesse Wood, Mesa, AZ (US); Andrew Pressnall, Highland, IL (US); Gregory Duez, O'Fallon, MO (US); Brady Allen Daughdrill, Denton, TX (US); Jay Newell, St. Charles, MO (US); Deacon B. Arokoyo, O'Fallon, MO (US); Harry Alexander Fuentes, O'Fallon, IL (US); Amisha Pandey, New Delhi (IN)

(73) Assignee: BANK OF AMERICA CORPORATION, Charlotte, NC (US)

(21) Appl. No.: 18/076,835

(22) Filed: Dec. 7, 2022

(51) Int. Cl. G06F 9/50; G06F 11/34

(52) U.S. Cl. CPC G06F 9/5027; G06F 11/3495

(57) ABSTRACT

Embodiments of the present invention generally comprises the steps of receiving resource distribution machine data from a population of resource distribution machines; continuously monitoring the resource distribution machine data and determining a statistical performance baseline for the population of resource distribution machines; isolating a subset of resource distribution machines of the population of resource distribution machines and deploy a pilot change to the subset of resource distribution machines; continuously monitoring resource distribution machine data of the subset of resource distribution machines post-deployment of the pilot change and compare the resource distribution machine data to the statistical performance baseline; identifying one or more deviations from the statistical performance baseline; generating one or more visual depictions of the one or more deviations; and automatically transmitting the one or more visual depictions to one or more user computing devices for display via a graphical user interface.

### FIELD OF THE INVENTION

The present invention embraces a system for enabling data-driven decisions regarding the functionality and maintenance of resource distribution machines.

### BACKGROUND

Replicating an entire resource distribution machine population and environmental conditions is not feasible with conventional solutions which inherently makes planned changes unpredictable and prone to chance of failure. Changes made to a population of resource distribution machines, whether software or hardware based, are known to cause unexpected negative impacts to machine functionality, performance, reliability and customer experience in some cases. Additionally, the negative effects of the one or more changes made are not always readily apparent until the one or more changes are fully deployed to the population. Additionally, adhering to typical control metrics that are overly restrictive may create false alarms, leading to a potential waste of time and effort to address ordinary issues in a population of resource distribution machines.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for providing automated issue diagnosis for a fleet of physical resource machines with the use of multi-channel data sampling and analysis. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention generally includes the steps of: receive resource distribution machine data from a population of resource distribution machines; continuously monitor the resource distribution machine data and determine a statistical performance baseline for the population of resource distribution machines; isolate a subset of resource distribution machines of the population of resource distribution machines and deploy a pilot change to the subset of resource distribution machines; continuously monitor resource distribution machine data of the subset of resource distribution machines post-deployment of the pilot change and compare the resource distribution machine data to the statistical performance baseline; identify one or more deviations from the statistical performance baseline; generate one or more visual depictions of the one or more deviations; and automatically transmit the one or more visual depictions to one or more user computing devices for display via a graphical user interface.

In some embodiments, the resource distribution machine data comprises software and hardware component data.

In some embodiments, the pilot change comprises a software version update or a hardware component change.

In some embodiments, the subset of resource distribution machines comprises 10-15% of the population of resource distribution machines.

In some embodiments, the visual depiction comprises a chart of sub-categorized issue identifications and software versions over a time period across the population of resource distribution machines.

In some embodiments, the deviation comprises a pre-defined threshold of a statistical standard of deviation or multiple of standard of deviation from the statistical baseline.

In some embodiments, continuously monitoring the resource distribution machine data and determining the statistical performance baseline for the population of resource distribution machines further comprises monitoring the population of resource distribution machines for a period of 90-120 days.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for automated issue diagnosis for a fleet of physical resource machines with the use of multi-channel data sampling and analysis, in accordance with an embodiment of the invention;

FIG. 2 provides a block diagram illustrating the entity system 200 of FIG. 1, in accordance with an embodiment of the invention;

FIG. 3 provides a block diagram illustrating a resource distribution device 400 of FIG. 1, in accordance with an embodiment of the present invention;

FIG. 4 provides a block diagram for a plurality of computing systems 500 of FIG. 1, in accordance with an embodiment of the present invention;

FIG. 5 provides a flowchart 600 illustrating a process flow for automated issue diagnosis for a fleet of physical resource machines with the use of multi-channel data sampling and analysis, in accordance with an embodiment of the invention;

FIG. 6 provides multiple visual depictions 700 of exemplary data output via an automated issue diagnosis for a fleet of physical resource machines with the use of multi-channel data sampling and analysis, in accordance with an embodiment of the invention;

FIG. 7 provides a visual depiction of an exemplary metric scorecard generated via an automated issue diagnosis for a fleet of physical resource machines with the use of multi channel data sampling and analysis, in accordance with an embodiment of the invention; and

FIG. 8 provides a high-level flowchart 800 illustrating a process flow for automated issue diagnosis, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, the term “entity” or “resource entity” may be any institution which involves in distribution of resources such as financial transactions. In one embodiment, the term “entity” or “resource entity” may be any financial institution. As used herein, the term “resource distribution device” described herein may be any devices or financial instruments that are involved in distribution of resources such as cash, checks, electronic transfers, goods, services, vouchers, money orders or the like which may be performed using a resource distribution card (e.g., credit card, debit card, membership card, or the like). In some embodiments, the resource distribution device may be owned or maintained by a financial entity. In some embodiments, the resource distribution devices may be owned or maintained by a third party entity. In some embodiments of the present invention, the resource distribution device may be an Automated Teller Machine (ATM). In some embodiments of the present invention, the resource distribution device may be a POS device at a third party entity location.

As used herein, the term “third party entity” may be any outside entity who interacts with the entity of the invention. In some embodiments, the third party entity may be a customer of the entity. For example, the third party entity may be a vault management entity which delivers resources form the vault to multiple resource distribution services and collects money from multiple resource distribution devices and other third party entity locations to deliver it back to the vault. In other embodiments, the third party entity may be a manufacturer, installer, manager, or the like, of one or more resource distribution devices. In other embodiments, the third party entity may be a trusted custodian, land owner, site manager, software developer, parts-manufacturer, or the like, which is in any way related to the process of managing and operating one or more resource distribution devices. As used herein, the term “resource delivery vehicle” may be any armored truck which is maintained by a third party entity or the entity of the invention. In some embodiment, the resource delivery vehicle may be maintained by the resource entity directly. As described herein, the term “user” may be an employee of the entity or of a third party entity. In other embodiments, the term “user” may refer to a customer of the entity that interacts with one or more resource distribution devices to obtain resources or manage a resource account.

Generally, the invention is directed to the management of pilot resource distribution machine changes on a subset of a total population of resource distribution machines (ATMs). The process includes identifying a first 10-15% of the entire resource distribution machine fleet or population, which is generally the percentage of the total population of machines requires to represent the array of differing machine characteristics in statistically accurate manner (e.g., different models, configurations, or the like, which may react differently to changes in software or hardware). In addition to selecting a threshold number of resource distribution machines, it is also generally understood that resource distribution machines with highest transaction volume should be used or included in a statistical analysis of pilot changes to ensure understanding of total exposure to potential problems and provide an opportunity to identify issues with these especially critical machines. The invention includes using categorized performance metrics to establish a statistical baseline based on the 90-120 days prior to any change(s) being made to either software or hardware components of the resource distribution machine population. Generating a statistical baseline may comprise using averages and limits (Average+XStandard Deviation) for each performance metric category. The invention also includes reviewing baseline metrics to determine necessary exclusions (outliers than compromise the Averages and Limits) and omit any highly abnormal data points that may lead to false alerts. Once a baseline is established, the process of the invention includes collecting and reviewing performance data over the days following the change(s) made. At this point, users of the invention may research any statistically significant anomaly to determine if it could be related to the change(s) made or if the anomaly represents a typically occurring, understandable issue. Generally speaking, it is understood that any data point more than the mean combined with the standard deviation (e.g., whatever standard of deviation is set, such as 1 sigma, 2 sigma, 3 sigma, or the like) should be researched. Data sets with a high “coefficient of variation” may need more than 1 standard deviation combined with the mean to avoid false positives. The invention further includes the ability to share or escalate relevant findings to make a data driven decision of expand/continue deployment of the change(s) or to stop and mitigate further if a negative impact is too great.

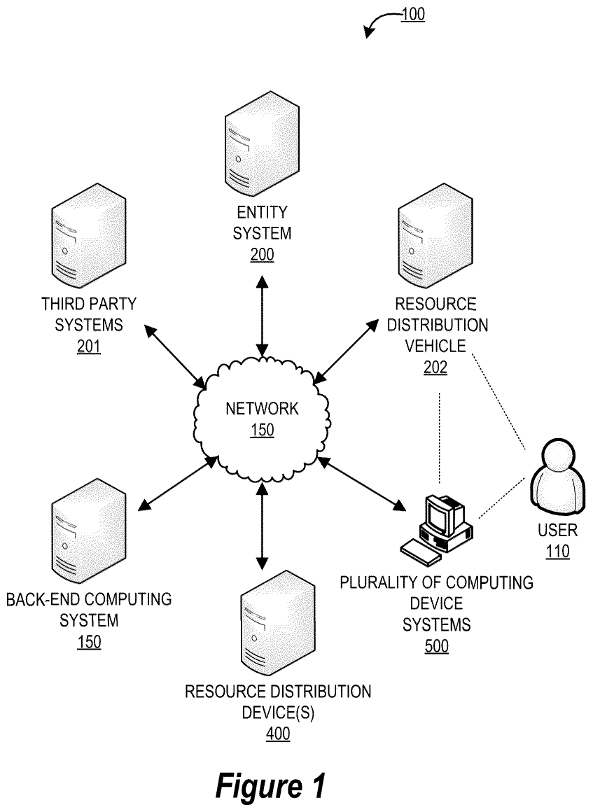

FIG. 1 provides a block diagram illustrating a system environment 100 for quantum optimization of resource routing. As illustrated in FIG. 1, the environment 100 includes a back-end computing system 150, resource distribution devices 400, entity system 200, one or more third party systems 201, and one or more resource distribution vehicles 202. In some embodiments, the resource distribution devices 400 may be operated, maintained, and/or controlled by the back-end computing system 150. In some embodiments, the resource distribution devices 400 may be operated, maintained, and/or controlled by the entity systems 200. In some embodiments, the resource distribution devices 400 may be operated, maintained, and/or controlled by both the back-end computing system 150 and the entity system 200. In some embodiments, the one or more resource distribution vehicles 202 may be operated, maintained, and/or controlled by the third party entity systems 201. In some other embodiments, the one or more resource distribution vehicles 202 may be operated, maintained, and/or controlled by the entity system 200. One or more users 110 may be included in the system environment 100, where the users 110 interact with the other entities of the system environment 100 via a user interface of the resource distribution device 400. The one or more users 110 may be any user in the resource distribution vehicle 202. For example, the user 100 may be a driver of the resource distribution vehicle 202.

In some embodiments, the back-end computing system 150 may be a part of the entity system. In such an embodiment, the back-end computing system 150 may transmit control signals remotely to the resource distribution device 400 to perform one or more actions and the computing devices described herein. In some embodiments, the back-end computing system 150 may be a remote and independent system which interacts with other systems in the system environment to perform one or more steps described herein. In such an embodiment, the system remotely communicates and/or manages the resource distribution vehicle 202, resource distribution devices 400, and/or computing device systems 400. In some embodiments, the back-end computing system 150 may be a part of the resource delivery vehicle 202, the resource distribution device 400, or the computing device system.

The entity system(s) 200 may be any system owned or otherwise controlled by an entity to support or perform one or more process steps described herein. The entity may be any entity which is involved in financial transactions. In some embodiments, the entity is a financial institution. The back-end computing system 150 and the resource distribution device 400 communicate with entity system 200 to perform one or more steps described herein.

The back-end computing system 150, the entity system 200, the resource distribution device 400, the third party system 201, the computing device system 400, and/or the resource distribution vehicle 202 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

In some embodiments, a quantum optimization engine may be core elements of an application, or part of an application that serves as a foundation for a larger piece of software and drives the functionality of the software in the back-end computing system 150. In accordance with the present systems and methods, a back-end computing system 150 may be adapted for integration into the system. The back-end computing system 150 may be configured for continuous operation, or it may be configured to be called upon/activated only when necessary to solve a specific problem (e.g., an optimization problem) that the back-end computing system 150 is particularly well-suited to solve. The back-end computing system 150 may, for example, be configured as a disposable, single-shot system (i.e., a system having a short lifespan or active time) for performing a single or small number of computations (if identified as necessary by the system) that govern a behavior of the system. Configuring the back-end computing system 150 as a disposable, single-shot system has the advantage of relaxing a number of design specifications that are otherwise necessary to provide the continuous, long-term operation typically expected in the known quantum computing arts. In accordance with the present systems and methods, the back-end computing system 150 may be configured to receive data from the system and perform a quantum computing operation (e.g., using the quantum optimization engine) in real-time.

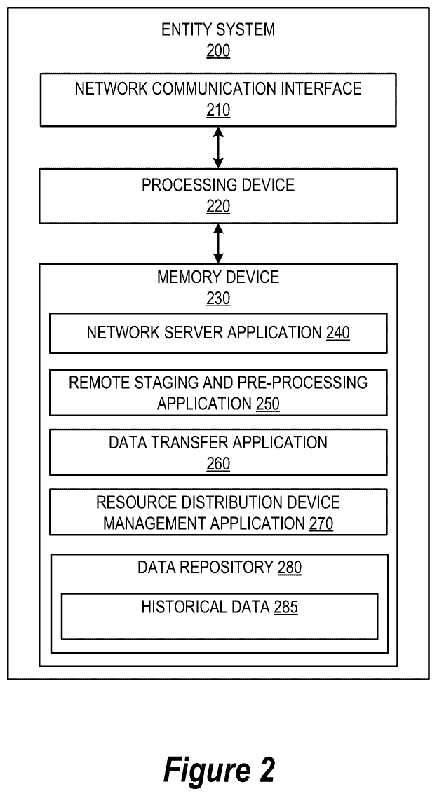

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a network server application 240, a remote staging and pre-processing application 250, a data transfer application 260, a resource distribution device management application 270, and a data repository 280 comprising historical data 285. The historical data 285 may be any transactions related historical data. The computer-executable program code of the network server application 240, the remote staging and pre-processing application 250, the data transfer application 260, the resource distribution device management application 270 may instruct the processing device 220 to perform certain logic, data-extraction, and data-storing functions of the entity system 200 described herein, as well as communication functions of the entity system 200.

The network server application 240, the remote staging and pre-processing application 250, the data transfer application 260, the resource distribution device management application 270 are configured to store data in the data repository 280 or to use the data stored in the data repository 280 when communicating through the network communication interface 210 with the back-end computing system 150, the resource distribution device 400, and the resource distribution vehicle 202 to perform one or more process steps described herein. In some embodiments, the entity system 200 may receive instructions from the back-end computing system 150 via the remote staging and pre-processing application 250 to perform certain data transfer operations to the resource distribution vehicle 202 and/or the resource distribution device 400. Upon receiving the instructions from the back-end computing system 150, the entity system 200 transfers data via the data transfer application 260.

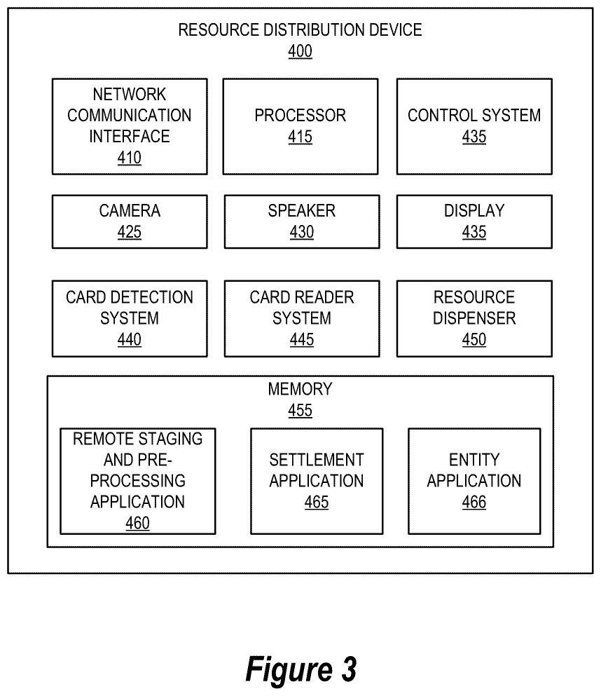

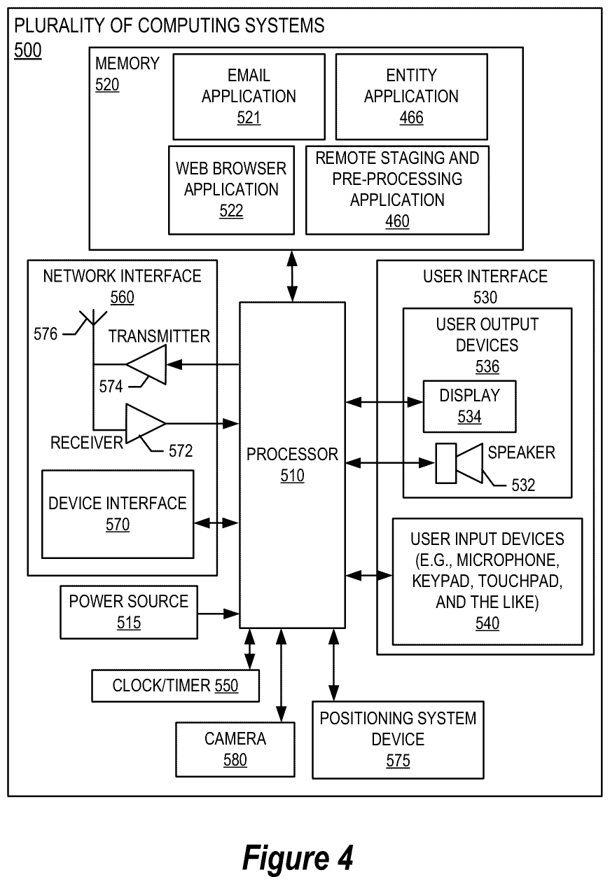

FIG. 3 provides a block diagram of the resource distribution device 400, in accordance with an embodiment of the present invention. As illustrated in FIG. 4, in one embodiment of the invention, the resource distribution device 400 includes a processor 415 operatively coupled to a network communication interface 410, a memory component 455, a control system 435, a camera 425, a speaker 430, a display 435, a card detection system 440, a card reader system 445, and a resource dispenser 450. The resource distribution device may include other components such as bar code scanner, resource counter, to perform multiple functions of the resource distribution devices 400.

It should be understood that the memory component 455 may include one or more databases or other data structures/repositories. The memory component 455 also includes computer-executable program code that instructs the processor 415 to operate the network communication interface 410 to perform certain communication functions of the resource distribution device 400 described herein and also instructs the processor 415 to cause the control system 435 to perform certain actions of the resource distribution device 400 including, but not limited to, dispensing resources, displaying messages on the display 435, performing resource count, or the like. In one embodiment, the memory component may include a remote staging and pre-processing application 460 provided by the back-end computing system 150, an entity application 466 provided by the entity system 200, and a settlement application 465. In some embodiments, the memory component 455 may include only the remote staging and pre-processing application 460 which may allow the resource distribution device 400 to communicate with the entity system 200. Based on the instructions and control signals received from the back-end computing system 150 via network communication interface and the remote staging and pre-processing application 460, the processor 415 via the control system 435 may operate the resource distribution device 400 such as displaying messages on the display 435, completing settlement process, or to perform certain other actions described herein.

FIG. 4 provides a block diagram illustrating a plurality of computing systems 500 of FIG. 1 in more detail, in accordance with embodiments of the invention. The plurality of computing systems 500 are associated with the plurality of users 110. In one embodiment the plurality of users 110 may be an employee, contractor, or otherwise affiliated with the entity of the plurality of entity systems 200. However, it should be understood that a mobile telephone is merely illustrative of one type of plurality of computing systems 500 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the plurality of computing systems 500 include a processor 510 communicably coupled to such devices as a memory 420, user output devices 536, user input devices 540, a network interface 560, a power source 515, a clock or other timer 550, a camera 580, and a positioning system device 575. The processor 510, and other processors described herein, generally include circuitry for implementing communication and/or logic functions of the plurality of computing systems 500. For example, the processor 510 may include a digital signal processor device, a microprocessor device, and various analog to digital converters, digital to analog converters, and/or other support circuits. Control and signal processing functions of the plurality of computing systems 500 are allocated between these devices according to their respective capabilities. The processor 510 thus may also include the functionality to encode and interleave messages and data prior to modulation and transmission. The processor 510 can additionally include an internal data modem. Further, the processor 510 may include functionality to operate one or more software programs, which may be stored in the memory 520. For example, the processor 510 may be capable of operating a connectivity program, such as a web browser application 522. The web browser application 522 may then allow the plurality of computing systems 500 to transmit and receive web content, such as, for example, location-based content and/or other web page content, according to a Wireless Application Protocol (WAP), Hypertext Transfer Protocol (HTTP), and/or the like.

The processor 510 is configured to use the network interface 560 to communicate with one or more other devices on the network 150. In this regard, the network interface 560 includes an antenna 576 operatively coupled to a transmitter 574 and a receiver 572 (together a “transceiver”). The processor 510 is configured to provide signals to and receive signals from the transmitter 574 and receiver 572, respectively. The signals may include signaling information in accordance with the air interface standard of the applicable cellular system of the network 150. In this regard, the plurality of computing systems 500 may be configured to operate with one or more air interface standards, communication protocols, modulation types, and access types. By way of illustration, the plurality of computing systems 500 may be configured to operate in accordance with any of a number of first, second, third, and/or fourth-generation communication protocols and/or the like. For example, the plurality of computing systems 500 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The plurality of computing systems 500 may also be configured to operate in accordance with non-cellular communication mechanisms, such as via a wireless local area network (WLAN) or other communication/data networks.

As described above, the plurality of computing systems 500 has a user interface that is, like other user interfaces described herein, made up of user output devices 536 and/or user input devices 540. The user output devices 536 include a display 530 (e.g., a liquid crystal display or the like) and a speaker 532 or other audio device, which are operatively coupled to the processor 510.

The user input devices 540, which allow the plurality of computing systems 500 to receive data from a plurality of users 110, may include any of a number of devices allowing the plurality of computing systems 500 to receive data from the plurality of users 110, such as a keypad, keyboard, touch-screen, touchpad, microphone, mouse, joystick, other pointer device, button, soft key, and/or other input device(s). The user interface may also include a camera 580, such as a digital camera.

The plurality of computing systems 500 may also include a positioning system device 575 that is configured to be used by a positioning system to determine a location of the plurality of computing systems 500. For example, the positioning system device 575 may include a GPS transceiver. In some embodiments, the positioning system device 575 is at least partially made up of the antenna 576, transmitter 574, and receiver 572 described above. For example, in one embodiment, triangulation of cellular signals may be used to identify the approximate or exact geographical location of the plurality of computing systems 500. In other embodiments, the positioning system device 575 includes a proximity sensor or transmitter, such as an RFID tag, that can sense or be sensed by devices known to be located proximate a merchant or other location to determine that the plurality of computing systems 500 is located proximate these known devices.

The plurality of computing systems 500 further includes a power source 515, such as a battery, for powering various circuits and other devices that are used to operate the plurality of computing systems 500. Embodiments of the plurality of computing systems 500 may also include a clock or other timer 550 configured to determine and, in some cases, communicate actual or relative time to the processor 510 or one or more other devices.

The plurality of computing systems 500 also includes a memory 520 operatively coupled to the processor 510. As used herein, memory includes any computer readable medium (as defined herein below) configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory can additionally or alternatively include an electrically erasable programmable read-only memory (EEPROM), flash memory or the like.

The memory 520 can store any of a number of applications which comprise computer-executable instructions/code executed by the processor 510 to implement the functions of the plurality of computing systems 500 and/or one or more of the process/method steps described herein. For example, the memory 520 may include such applications as a conventional web browser application 522, an email application 521, an entity application 466, a remote staging and pre-processing application 460, or the like. The email application 521, the web browser application 522, the remote staging and pre-processing application 460 may allow the plurality of users 110 to communicate with the plurality of entity systems 500, the back-end computing system 150, resource distribution devices 500, resource distribution vehicle 202, and the third party server 201. The entity application 466 allows the one or more users 110 to interact with the plurality of entity systems 200. The remote staging and pre-processing application 460 may be present in the memory 520 of the plurality of computing systems 500 to allow direct communication with the back-end computing system 150 and also the resource distribution devices 500.

The memory 520 can also store any of a number of pieces of information, and data, used by the plurality of computing systems 500 and the applications and devices that make up the plurality of computing systems 500 or are in communication with the plurality of computing systems 500 to implement the functions of the plurality of computing systems 500 and/or the other systems described herein.

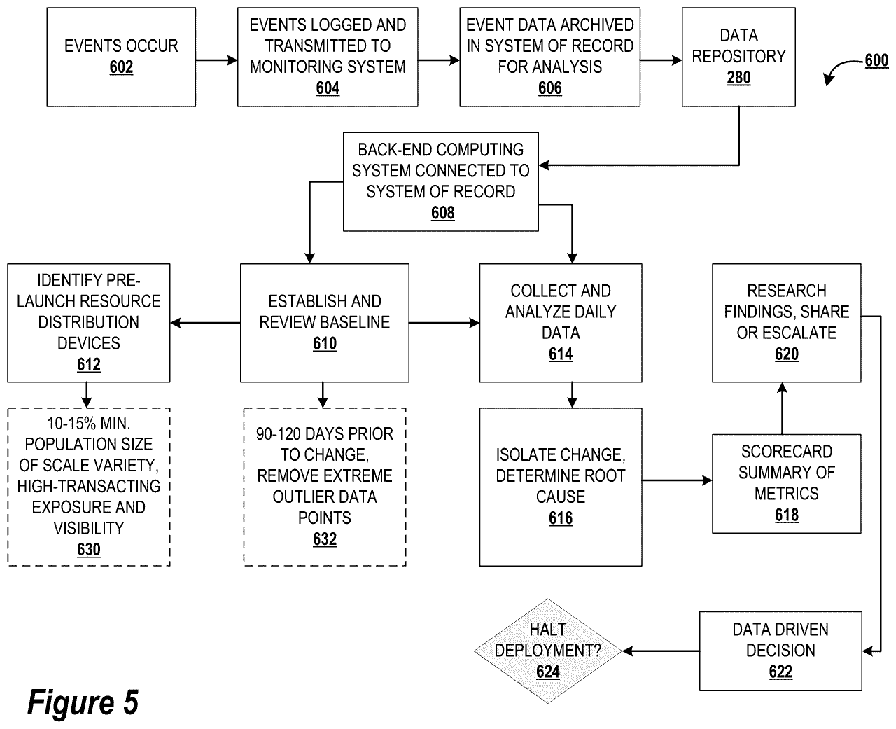

FIG. 5 provides a flowchart 600 illustrating a process flow for automated issue diagnosis for a fleet of physical resource machines with the use of multi-channel data sampling and analysis, in accordance with an embodiment of the invention. As discussed, the invention is directed to the management of pilot resource distribution machine changes on a subset of a total population of resource distribution machines (ATMs). The process includes identifying a first 10-15% of the entire resource distribution machine fleet or population, which is generally the percentage of the total population of machines requires to represent the array of differing machine characteristics in statistically accurate manner (e.g., different models, configurations, or the like, which may react differently to changes in software or hardware). In addition to selecting a threshold number of resource distribution machines, it is also generally understood that resource distribution machines with highest transaction volume should be used or included in a statistical analysis of pilot changes to ensure understanding of total exposure to potential problems and provide an opportunity to identify issues with these especially critical machines. The invention includes using categorized performance metrics to establish a statistical baseline based on the 90-120 days prior to any change(s) being made to either software or hardware components of the resource distribution machine population. Generating a statistical baseline may comprise using averages and limits (Average+XStandard Deviation) for each performance metric category. The invention also includes reviewing baseline metrics to determine necessary exclusions (outliers than compromise the Averages and Limits) and omit any highly abnormal data points that may lead to false alerts. Once a baseline is established, the process of the invention includes collecting and reviewing performance data over the days following the change(s) made. At this point, users of the invention may research any statistically significant anomaly to determine if it could be related to the change(s) made or if the anomaly represents a typically occurring, understandable issue. Generally speaking, it is understood that any data point more than the mean combined with the standard deviation (e.g., whatever standard of deviation is set, such as 1 sigma, 2 sigma, 3 sigma, or the like) should be researched. Data sets with a high “coefficient of variation” may need more than 1 standard deviation combined with the mean to avoid false positives. The invention further includes the ability to share or escalate relevant findings to make a data driven decision of expand/continue deployment of the change(s) or to stop and mitigate further if a negative impact is too great.

As shown in block 602, the invention monitors the resource distribution machines to determine if events occur, at which point the events are logged and transmitted to a monitoring system, as shown in block 604. The event data is archives in a system of record, such as data repository 280, as indicated in block 606. The back-end computing system is operatively connected to the system of record (SOR), as indicated in block 608, in order to easily access compiled data from the resource distribution machines. It is understood that the data compiled in the SOR may be normalized, reformatted, or otherwise standardized before being processed by the back-end computing system 150.

As shown in block 612, the invention identifies pre-launch (i.e., prior to a change being implemented) resource distribution devices which are selected to conduct a baseline analysis. As discussed, this number is generally about 10-15%, minimum, of the total resource distribution machine population; however, it is understood that certain extenuating circumstances may require the subset of the population to represent more than this percentage, such as in cases where there are a higher number of “critical” machines with high transaction exposure and visibility, or high volume which need to be included in the analysis regardless to avoid negative impact to these high traffic areas, as indicated in block 630. As shown in block 610, the process includes establishing and reviewing a baseline to determine normally occurring anomalies, issues, and problems associated with the current deployment of software version and hardware components currently being used across the resource distribution machine population. Categories of resource distribution machine analysis may include resource servicing, network, and hardware, generally. In terms of resource servicing, sub-categories may include, but are not limited to, general servicing (refilling resource reserves), bin-full errors, cash-out errors, or the like. In terms of network errors, sub-categories may include, but are not limited to, communication errors or host availability errors, or the like. In terms of hardware issues, sub-categories may include, but are not limited to, depositor, dispenser, or card reader issues, or the like. As indicated in block 632, the 90-120 days prior to the implementation of any change to the resource distribution machines is typically monitored to establish the baseline in order to remove any extreme outlier data points.

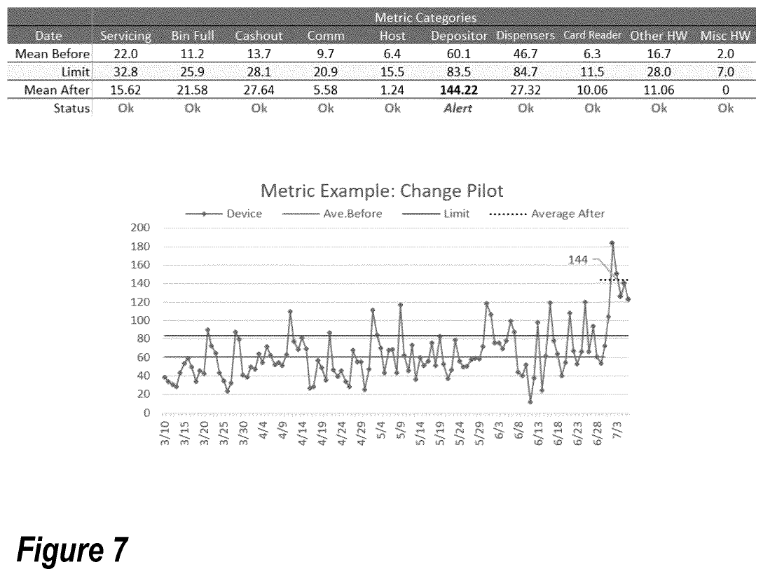

Next, as shown in block 614, the process of the invention may include collecting and analyzing daily data. It is understood that this step is ongoing and may revert back to step 610 in order to inform the establishment of a review baseline. For instance, a review baseline may comprise the collection of data for a period of 90-120 days prior to the implementation of a software or hardware change, while the collection and analysis of daily data may comprise only a few days of data initially after changes are implemented in order to identify any issues quickly and respond in a timely manner. The system may then proceed to step 616, wherein the system isolates changes in the daily data, such as a spike in errors of a particular subcategory or with regard to specific machine types, machine locations, or the like, and attempts to determine a root cause by nature of the correlation between the implemented change and the spike in particular event occurrences. At this point, a scorecard may be generated which shows a summary of these metrics in an easily viewable format, as shown in FIG. 7.

As shown in block 620, the data collected during steps 610 and 614 are researched, shared, or escalated by or to the necessary parties in order to identify or address any potential issues as a result of an implemented software or hardware change. If the pilot changes are generating an acceptable data stream that shows no obvious, chronic, or critical issues, the process may proceed to block 610, wherein factual data to support deployment may be forwarded to entity administrators or third-party entity representatives. A data driven decision may be executed or recommended by the system, as shown in block 622. This decision may include halting deployment, as shown in decision diamond 624.

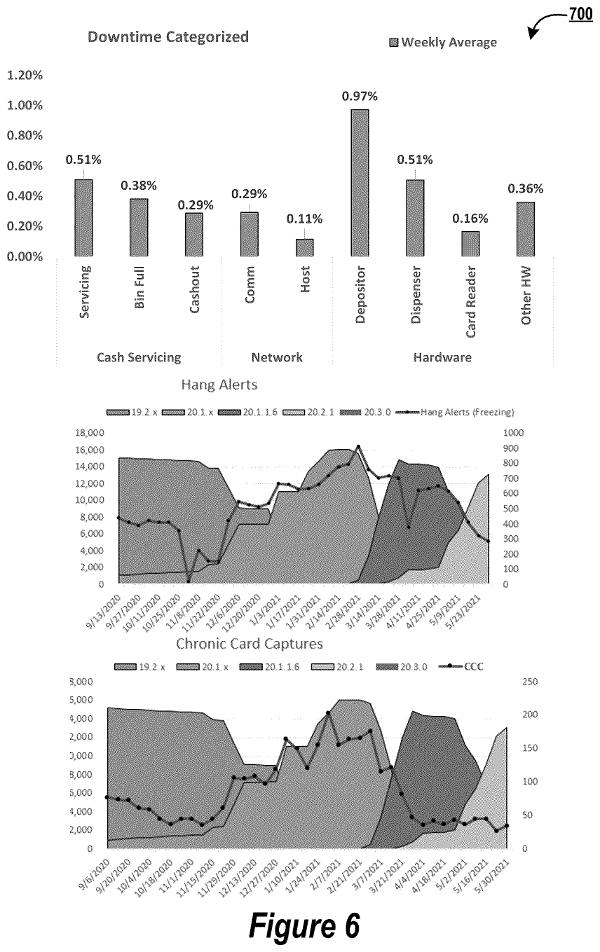

FIG. 6 provides multiple visual depictions 700 of exemplary data output via an automated issue diagnosis for a fleet of physical resource machines with the use of multi-channel data sampling and analysis, in accordance with an embodiment of the invention. As shown in FIG. 6, data output may be collected and visualized to show a weekly average of downtime after baseline data is collected for a threshold period. The data may be sub-categorized according to the categories discussed with regard to FIG. 5, which include servicing, bin full, cash out, communications, host, depositor, dispenser, card reader, or other hardware issues. It is understood that this is not an exhaustive list of hardware components or potential issues that may be monitored, but rather an exemplary embodiment to show multiple types of data which can be analyzed to determine relevant issues or events that may need to be addressed by the entity. It is understood that the data received from the resource distribution machines may comprise data across multiple different channels of communication. For instance, in some embodiments, certain hardware components may be designed to operatively communicate with the entity systems in real-time on an ongoing basis. In other embodiments, the entity may receive batch-data information on an hourly or daily basis, or the like from the resource distribution machines directly, or in the form of a data report from one or more third party entities which manage one or more resource distribution machines. In this way, the invention is designed to consolidate data from multiple channels of communication and normalize or translate the data in a manner which allows the entity to conduct analysis on the data set as a whole. This consolidation step provides an improvement over conventional systems wherein the data consolidation step may be time consuming and involve manual involvement of one or more users in order to ensure that data is in the correct format or does not contain duplicates, errors, or the like. In this way, the automated issue diagnosis using multi-channel data sampling provides a practical solution to the problem of assessing multiple different machine-types across multiple different managing entities, or the like.

Shown further down in FIG. 6, toward the middle and bottom of the Figure, are two examples of sub-category-specific breakdowns of machine performance over time, which includes the roll-out of multiple different software versions. For instance, the graphical visualization can be interpreted as showing total number of resource distribution machines on the left y-axis, total number of alerts in the particular subcategory on the right y-axis, and relevant dates moving from past to present on the x-axis. Shown on the body of the graph is a colorized visualization of the overall number of machines which have been updated to each corresponding software version, as indicated in the legend toward the top of each statistical visualization (e.g., release 19.2x, release 20.1x, release 20.1.1.6x, or the like). It is understood that the colorized curve-areas on the visualization represent the number of machines which have been upgraded to each software version. Overlaid on the graph is a red line indicating the number of alerts related to each problem subcategory (e.g., hanging, card captures, or the like) that also coincides with the passage of time on the x-axis. In this way, the user is given a visual depiction of how alerts either increase or decrease over time as the machine population is updated from one software version to the next.

FIG. 7 provides a visual depiction of an exemplary metric scorecard generated via an automated issue diagnosis for a fleet of physical resource machines with the use of multi-channel data sampling and analysis, in accordance with an embodiment of the invention. As indicated in FIG. 7, in some embodiments, the metric scorecard comprises multiple views of information such as a table highlighting all subcategories of error types before and after a change implementation, and a drilled-down view of specific error mapping of depositor errors. As shown in the table toward the top of FIG. 7, the statistical mean and limit can be calculated based on the preceding period before the change is implemented. For instance, the limit may represent a standard deviation or multiple standard deviations considered acceptable or normal under pre-launch, pre-change conditions or the like. After a change pilot has been deployed to a test group of machines, errors in each category can be tracked and mapped as shown on the line graph toward the bottom of FIG. 7. The x-axis represents data recorded over 5-day intervals, while the y-axis coincides with errors in the particular subcategory of depositor errors. As shown in either depiction, an alert may be automatically triggered if the mean after the change implementation is recorded as being above the pre-set limit value.

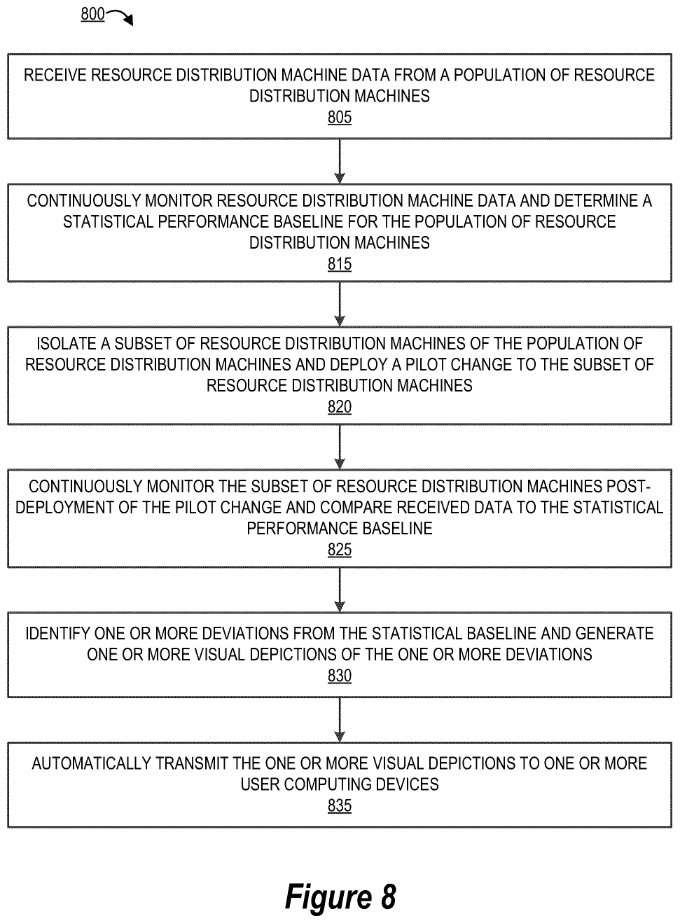

FIG. 8 provides a high-level flowchart 800 illustrating a process flow for automated issue diagnosis, in accordance with an embodiment of the invention. As shown in block 805, the process begins whereby the system receives resource distribution machine data from a total population of resource distribution machines. As further indicated in block 815, the system continuously monitors the resource distribution machine data and determines a statistical baseline for the population of resource distribution machines. As previously discussed, the period for determining a statistical performance baseline is typically 90-120 days of continuous resource distribution machine operation; however, it is understood that any time period wherein no new software deployments or hardware updates across a material number of resource distribution machines takes place is generally what is required to form a statistical performance baseline for comparison with data after the deployment of any pilot-change.

As shown in block 820, the process continues wherein the system isolates a subset of resource distribution machines of the population of resource distribution machines and deploys a pilot change to the subset of resource distribution machines. As discussed, the subset of the population of resource distribution machines is ideally a large enough percentage of the population to capture a statistically accurate and diverse representation of all machine types, configurations, geographic locations, third party managements, or the like. In addition, the percentage value of the subset of resource distribution machines should be balanced to include as many critical machines as possible (e.g., machines with a relatively high amount of traffic or located in critical locations), while still maintaining a low enough percentage to ensure that the overall population of machines in any given geographic area still includes some operational machines in the event that the pilot change causes any catastrophic failures or downtime for the machines. In some embodiments, this percentage may represent about 10-15% of the overall population of resource distribution machines.

Moving further to block 825, the system may continuously monitor the subset of resource distribution machines post-deployment of the pilot change and compare received data to the statistical performance baseline. In doing so, the system may identify one or more deviations from the statistical baseline and generate one or more visual depictions of the one or more deviations, as indicated in block 830. In some embodiments, the visual depictions may be similar to those outlined in FIG. 6, wherein the visual depictions may comprise categorized downtime according to device component category, or certain specific failure or issue types across the resource distribution machine population as pilot-changes are rolled out to the machine population over time. Finally, as shown in block 835, the system may automatically transmit the one or more visual depictions to one or more user computing devices of the entity or a third party entity such that various users, administrators, representatives, or the like, can address any deviations from the statistical performance baseline that may represent an issue that requires addressing either from the backend computing systems or by conducting in-person service calls to the machines themselves.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for resource routing using quantum optimization, the system comprising:
at least one transitory storage device; and
at least one processing device coupled to the at least one non-transitory storage device, wherein the at least one processing device is configured to:
receive resource distribution machine data from a population of resource distribution machines;
continuously monitor the resource distribution machine data and determine a statistical performance baseline for the population of resource distribution machines;
isolate a subset of resource distribution machines of the population of resource distribution machines and deploy a pilot change to the subset of resource distribution machines;
continuously monitor resource distribution machine data of the subset of resource distribution machines post-deployment of the pilot change and compare the resource distribution machine data to the statistical performance baseline;
identify one or more deviations from the statistical performance baseline;
generate one or more visual depictions of the one or more deviations; and
automatically transmit the one or more visual depictions to one or more user computing devices for display via a graphical user interface.

2. The system of claim 1, wherein the resource distribution machine data comprises software and hardware component data.

3. The system of claim 1, wherein the pilot change comprises a software version update or a hardware component change.

4. The system of claim 1, wherein the subset of resource distribution machines comprises 10-15% of the population of resource distribution machines.

5. The system of claim 1, wherein the visual depiction comprises a chart of sub-categorized issue identifications and software versions over a time period across the population of resource distribution machines.

6. The system of claim 1, wherein the deviation comprises a pre-defined threshold of a statistical standard of deviation or multiple of standard of deviation from the statistical baseline.

7. The system of claim 1, wherein continuously monitoring the resource distribution machine data and determining the statistical performance baseline for the population of resource distribution machines further comprises monitoring the population of resource distribution machines for a period of 90-120 days.

8. A computer program product for resource routing using quantum optimization, the computer program product comprising a non-transitory computer-readable storage medium having computer-executable instructions for causing a computer processor to perform the steps of:
receiving resource distribution machine data from a population of resource distribution machines;
continuously monitoring the resource distribution machine data and determining a statistical performance baseline for the population of resource distribution machines;
isolating a subset of resource distribution machines of the population of resource distribution machines and deploy a pilot change to the subset of resource distribution machines;
continuously monitoring resource distribution machine data of the subset of resource distribution machines post-deployment of the pilot change and compare the resource distribution machine data to the statistical performance baseline;
identifying one or more deviations from the statistical performance baseline;
generating one or more visual depictions of the one or more deviations; and
automatically transmitting the one or more visual depictions to one or more user computing devices for display via a graphical user interface.

9. The computer program product of claim 8, wherein the resource distribution machine data comprises software and hardware component data.

10. The computer program product of claim 8, wherein the pilot change comprises a software version update or a hardware component change.

11. The computer program product of claim 8, wherein the subset of resource distribution machines comprises 10-15% of the population of resource distribution machines.

12. The computer program product of claim 8, wherein the visual depiction comprises a chart of sub-categorized issue identifications and software versions over a time period across the population of resource distribution machines.

13. The computer program product of claim 8, wherein the deviation comprises a pre-defined threshold of a statistical standard of deviation or multiple of standard of deviation from the statistical baseline.

14. The computer program product of claim 8, wherein continuously monitoring the resource distribution machine data and determining the statistical performance baseline for the population of resource distribution machines further comprises monitoring the population of resource distribution machines for a period of 90-120 days.

15. A computerized method for resource routing using quantum optimization, the method comprising:
receiving resource distribution machine data from a population of resource distribution machines;
continuously monitoring the resource distribution machine data and determining a statistical performance baseline for the population of resource distribution machines;
isolating a subset of resource distribution machines of the population of resource distribution machines and deploy a pilot change to the subset of resource distribution machines;
continuously monitoring resource distribution machine data of the subset of resource distribution machines post-deployment of the pilot change and compare the resource distribution machine data to the statistical performance baseline;
identifying one or more deviations from the statistical performance baseline;
generating one or more visual depictions of the one or more deviations; and
automatically transmitting the one or more visual depictions to one or more user computing devices for display via a graphical user interface.

16. The computerized method of claim 15, wherein the resource distribution machine data comprises software and hardware component data.

17. The computerized method of claim 15, wherein the pilot change comprises a software version update or a hardware component change.

18. The computerized method of claim 15, wherein the subset of resource distribution machines comprises 10-15% of the population of resource distribution machines.

19. The computerized method of claim 15, wherein the visual depiction comprises a chart of sub-categorized issue identifications and software versions over a time period across the population of resource distribution machines.

20. The computerized method of claim 15, wherein the deviation comprises a pre-defined threshold of a statistical standard of deviation or multiple of standard of deviation from the statistical baseline.
